(19) United States
(12) Patent Application Publication
(10) Pub. No.: US 2004/0095773 A1
(43) Pub. Date: May 20, 2004

(54) UNIVERSAL MOUNT LUMINAIRE

(76) Inventors: Robert J. Gaskins, Pleasanton, CA (US); Katsuhiro Unoki, Vallejo, CA (US)

Correspondence Address: JOHN F. SALAZAR, MIDDLETON & REUTLINGER, 2500 BROWN & WILLIAMSON TOWER, LOUISVILLE, KY, 40202, US

(21) Appl. No.: 10/020,811

(22) Filed: Dec. 12, 2001

(51) Int. Cl. F21V 11/00

(52) U.S. Cl. 362/370; 362/431; 362/396

(57) ABSTRACT

A universal mount luminaire is disclosed. The luminaire has a support arm which has integrated therein structure for both davit arm mounting and for direct pole mounting. The universal mount luminaire of the present invention also provides a leveling mechanism within the support mount or support arm so that in davit arm mounting, the luminaire may be properly angularly adjusted.

### BACKGROUND OF THE INVENTION

1. Technical Field of the Invention

The present invention relates to a universal mount lighting fixture or luminaire and in particular to a universal mount luminaire which has a combination direct davit arm and direct pole mount capability.

2. Review of the Prior Art

Wide area lighting luminaires have been previously provided for either pole mounting or for davit arm mounting. Wide area lighting luminaires may be mounted directly to a vertically extending pole for placement of the luminaire at a sufficient height to provide adequate illumination. Alternatively, davit arm lighting may also be provided such that the luminaire extends outward past the end of the davit arm such as, for example, over roadways or other open unobstructed areas. With respect to these known luminaire systems, mounting on either a vertical pole or on a davit arm required either different luminaire designs or required external adapters to convert the product from one mounting type to another. None of the prior art illumination devices provide for mounting without the use of an external adapter on either a pole mount or a davit arm mount which would allow the luminaire to be utilized in a wide variety of circumstances without the necessity of obtaining various external adaptation devices.

### SUMMARY OF THE INVENTION

The universal mount luminaire of the present invention solves the above related drawbacks to the prior art wide area illumination systems such that the universal mount luminaire of the present invention is mountable both in a vertical pole mount position or with mounting to a davit arm.

It is therefore an object of the present invention to provide a universal mount luminaire which is mountable to a vertical pole and may be securely affixed thereto.

It is a further object of the present invention to provide a universal mount luminaire which may alternatively be mounted to a davit arm.

An even further object of the present invention is to provide a universal mount luminaire which extends outwardly and which is mountable to either a vertical pole mount or to an outwardly extending davit arm without the need for external adapters.

An even further object of the present invention is to provide a secure clamping mechanism for attachment of the universal mount luminaire of the present invention to an outwardly extending davit arm.

An additional object of the present invention is to provide a leveling mechanism such that when the luminaire of the present invention is affixed to an outwardly extending davit arm, the luminaire may be appropriately adjusted to the proper angular level to provide maximal illumination of the area below.

An even further object of the present invention is to provide a universal mount luminaire having a support arm extending outwardly therefrom, the support arm affixing directly to an attachment pole by means of a cast-in mounting plate having mounting holes therethrough.

The present invention provides for mechanically mounting the universal mount luminaire of the present invention directly to a pole or mast arm without the use of external adapters while still providing adequate support and attachment to the mounting pole.

The universal mount luminaire of the present invention provides a dual mount support arm, said support arm attachable to both a davit arm and a vertically extending pole. Configuration for attachment to either of a pole or a davit arm is incorporated into the support arm design.

The universal mount luminaire of the present invention is comprised of a housing which has extending outwardly therefrom a support arm. The support arm is adaptable for mounting on either a davit arm or on a standard pole for typical pole mounting. The support arm for the universal mount luminaire of the present invention is designed so that it may be received into the interior thereof the davit arm for secure clamping and affixation thereto while also allowing proper leveling of the luminaire to ensure adequate illumination of the area below. Further, the support arm for the universal mount luminaire of the present invention has an alternative mounting position for mounting on a mount plate which is on a distal end of the support arm opposite the luminaire housing. The mount plate at the distal end of the support arm may be curved so that it is flush with the circular pole to be mounted to while also providing mounting apertures therethrough in order to extend mounting bolts for proper affixation. The universal mount luminaire of the present invention provides a mechanism for properly mounting the luminaire to either a lighting pole or a davit arm without the necessity of an external adapter.

All of the above outlined objectives are to be understood as exemplary only and many more objectives of the invention may be gleaned from the disclosure herein. Therefore, no limiting interpretation of the objectives noted are to be understood without further reading of the entire specification, claims and drawings included herewith.

### DESCRIPTION OF THE FIGURES

A better understanding of the universal mount luminaire of the present invention may be had by reference to the attached drawings, wherein like numbers refer to like elements, and wherein:

FIG. 1 is a lower perspective view of the universal mount luminaire of the present invention;

FIG. 2 is a lower perspective view of the mounting arm for the universal mount luminaire depicted in FIG. 1;

FIG. 3 is a perspective view of the universal mount luminaire of the present invention configured in pole mount attachment;

FIG. 4 is a perspective view of the universal mount luminaire of the present invention configured with davit arm mount attachment;

FIG. 5 is a side sectional view of the universal mount luminaire of the present invention;

FIG. 5a is a bottom view of the universal mount luminaire support arm affixed to a davit arm;

FIG. 6 is a side sectional view of the universal mount luminaire of the present invention affixed to a lighting pole.

### DETAILED DESCRIPTION OF THE PREFERRED EMBODIMENT

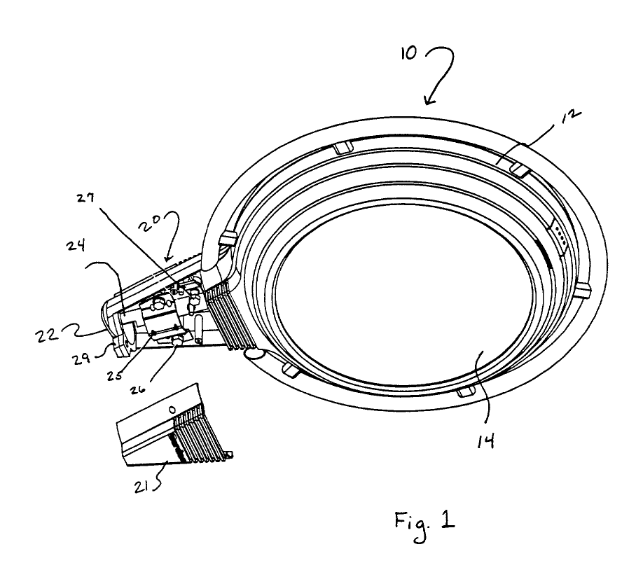

The universal mount luminaire 10 of the present invention is depicted in FIG. 1. As shown therein, the universal mount luminaire 10 is comprised of a housing 12 lamp or illumination source II, and a support arm 20, the support arm 20 provides for affixation of the luminaire 10 to a davit arm or to a standard upwardly extending lighting pole. As shown in FIG. 1, the universal mount luminaire 10 has, in this embodiment, a circular shaped housing with a lens on the lower end thereof through which an area may be illuminated. However, a significant number of variant housings may be utilized for a luminaire to incorporate aspects of the present invention and no limiting interpretations are to be understood from the selection of the particular luminaire described herein.

In the embodiment shown in FIG. 1, the luminaire housing 12 has an outwardly extending support mount or support arm 20, the support arm 20 having attachment mechanisms for receiving the davit arm or for attachment to a pole. The support arm 20, as depicted in FIG. 1 with the cover plate 21 removed, has mechanisms located therein for affixation to a davit arm while also having a mounting plate 29 for attachment to a mounting pole.

The support arm 20 is configured so as to be adaptable for either mounting to a davit arm or to a vertical surface such as a standard vertical light pole. If it is to be mounted along a davit arm, other mechanisms are provided within the support arm 20 in order to assure proper leveling of the universal mount luminaire 10. This includes a leveling bracket 24 with corresponding leveling screw 27 as well as a clamp bracket 25 for affixation around the davit arm.

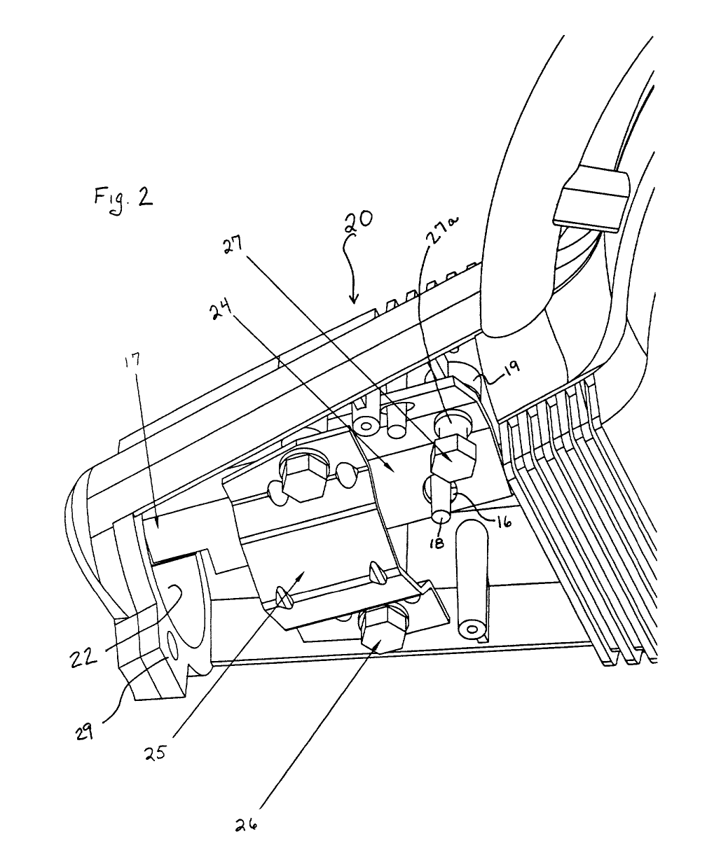

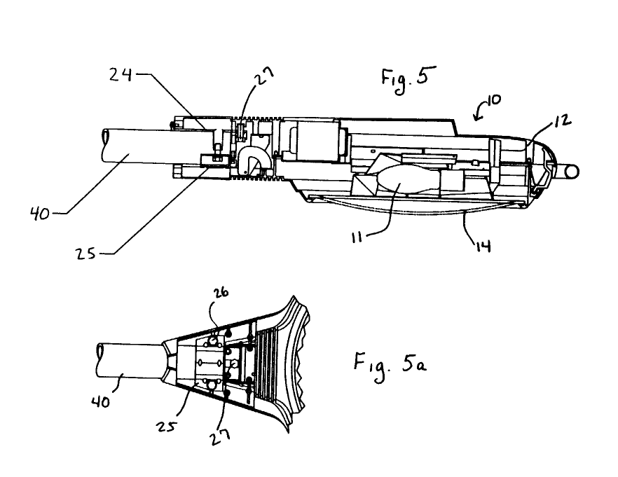

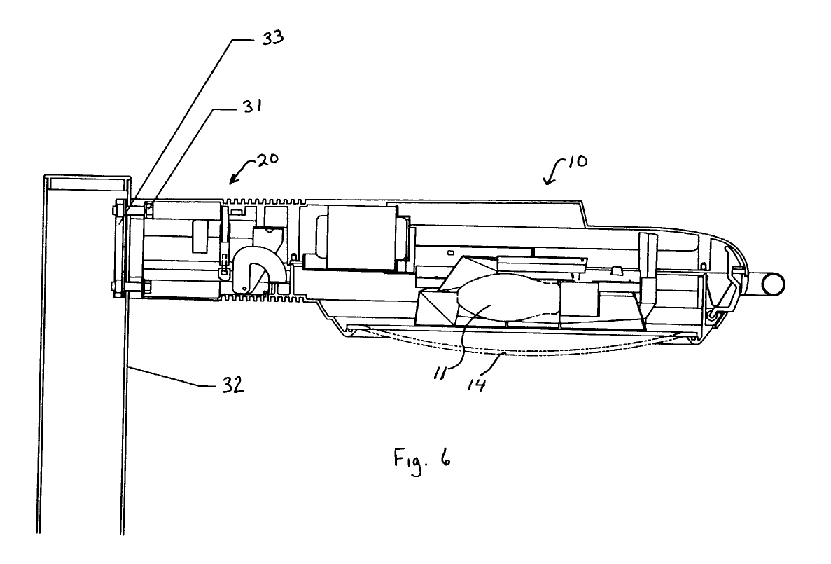

Davit arm attachment for the universal mount luminaire 10 of the present invention is more clearly shown in FIGS. 4, 5 and 5a wherein the davit arm 40 extends inwardly into the interior of the support arm 20. Thus, the davit arm aperture 22, more clearly depicted in FIG. 2, receives the davit arm 40 and allows the davit arm to be securely affixed to the support arm 20. As shown in FIG. 4, the davit arm extends into the support arm and is clamped to the interior thereof. In conjunction with FIG. 2, davit arm 40 is maintained securely affixed to the universal mount luminaire 10 of the present invention by a clamp bracket 25 which may partially surround the davit arm and securely affix the davit arm to the support arm of the luminaire 10. Clamp bracket 25 may have a plurality of clamp bolts 26 for securely attaching the davit arm to the support arm of the luminaire. A number of alternative attachment mechanisms as opposed to the clamp bracket 25 may be utilized so long as the davit arm is securely affixed to the support arm 20 or to the luminaire 10.

In conjunction with the clamp bracket 25 for mounting on a davit arm 40 depicted in FIG. 4 is a leveling bracket 24 which extends along the upper portion, in the present example, of the davit arm in the interior of the support arm 20. The leveling bracket 24 may be adjusted appropriately by leveling bolt 27 so that the housing 12 of the universal mount luminaire 10 of the present invention is adequately positioned to maximize illumination of the area below. The leveling bolt 27 may be positioned such that upon clockwise or counter-clockwise threading of the leveling bolt 27, the luminaire may raise or lower to a desired angular pitch relative to the davit arm. Further, the leveling bolt 27 may be readily accessible after installation of the davit arm 40 into the davit arm aperture 22 and the clamp bracket 25.

As is shown in FIG. 4, the clamp bracket 25 surrounds a portion of the davit arm and compresses the davit arm against an upper portion of the support arm 20. As seen also in conjunction with FIG. 2, this upward force causes the davit arm to abut against the leveling bracket 24, as is also shown in FIG. 5. Thus, leveling bolt 27 may be accessible such that after secure affixation of the davit arm to the luminaire 10 after clamping of clamp bracket 25 around the davit arm, the luminaire may be adjusted in angular pitch by either threading or unthreading of the leveling bolt 27.

As additionally depicted in FIG. 5a, the davit arm 40 is securely retained by the clamp bracket 25 which affixes the clamp bracket to the support arm by the clamp bolts 26 which may be placed on either end of the clamp bracket 25. Further, as is shown in FIG. 5a, the leveling bolt may be readily accessible after installation of the davit arm into the support arm 20.

The leveling bracket 24 causes the raising and lowering of the luminaire by the leveling bolt 27. As shown in FIG. 2, leveling bolt 27 may be designed such that an outwardly extending flange 27a contacts the lower surface of the leveling bracket to provide an adequate contacting surface for raising and lowering the bracket 24.

The leveling bracket 24 located along the upper surface of the support arm 20 is securely affixed at one end 17 to the support arm. At the opposite end of the leveling bracket, at least one guiding aperture 16 is provided through which guiding post 18 extend downwardly therethrough. This opposite end may be biased in a downward position. Guiding post 18 extend downward from the top wall of the support arm and provide a travel position for said leveling bracket in the upward and downward direction such that the leveling bracket is properly guided. Leveling bolt 27 is threadably engaged into bolt receiving aperture 19 which is formed on the interior top wall of the support arm such that leveling bolt 27 may be threadably engaged into the interior thereof thereby allowing upward and downward travel of the bracket 24. Such upward and downward travel is properly guided by the aperture 16 and the post 18.

It is also understood that given the teachings of the present invention and the description herein, the universal mount luminaire 10 of the present invention may be designed such that the housing and support mount or arm are combined into a singular unit so that the support mount may still provide the functionality of receiving both a davit arm and mounting on a vertically extending lighting pole while also including therein the leveling mechanism described herein. Such alternative embodiments are considered to fall within the teachings and description herein and various other embodiments may be known which effect the combination of the housing and support arm structure.

Alternative examples of leveling mechanisms may be utilized as opposed to a laterally extending bracket 24 as depicted. Thus, singular leveling bolts or other structure may be utilized which raises or lowers the relationship between the support arm 20 or the housing 12 with respect to the davit arm 40. These variations in leveling mechanisms may be utilized and are felt to be encompassed within the teachings of the present invention and thus no unnecessary limitation is to be interpreted from the utilization of the specific leveling bracket depicted herein.

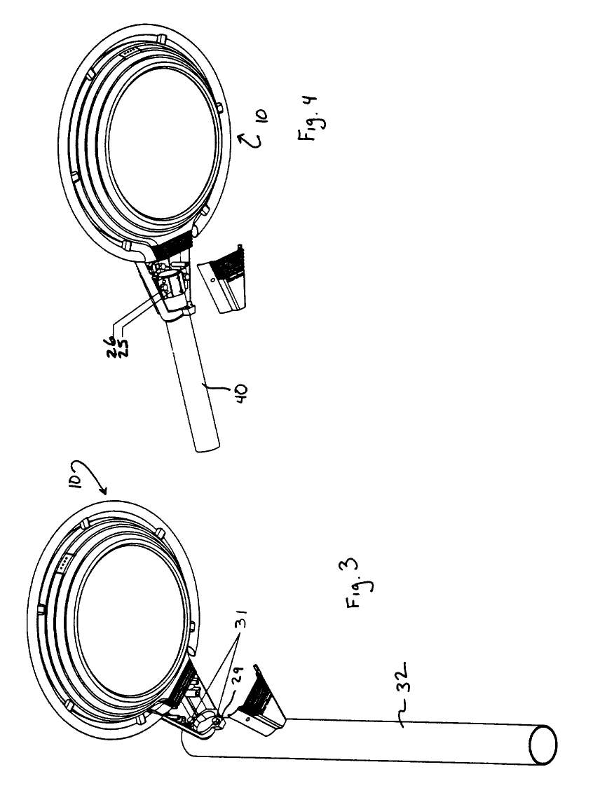

As further depicted in FIG. 3, the universal mount luminaire of the present invention may also be mounted to a vertically extending lighting pole 32. As shown in FIG. 3 and in conjunction with FIG. 6, the lighting pole 32 may be such that it is circular so that it may be desirable to have a curved mounting plate 29 which surrounds the davit arm aperture 22. The curved mounting plate 29 will allow a flush mounting of the support arm 20 to a lighting pole 32 as is shown.

As also shown therein, the mounting plate 29 may have apertures located thereon for receiving mounting bolts 31 so that the support arm 20 may be securely affixed to the lighting pole 32. Thus, as shown in FIG. 3 and in FIG. 6, the mounting bolts 31 extend through the rear wall of support arm formed by the mounting plate 29 and are received in an aperture formed in the lighting pole 32 and retained therein. As is further shown in FIG. 6, a mounting plate 33 may be provided on the interior of the lighting pole 32 to provide further support for mounting of the universal mount luminaire 10 as depicted. In the pole mount position as depicted in FIG. 6 and in FIG. 3, the leveling mechanism provided for in davit arm mounting is not necessary as the universal mount luminaire 10 is mounted flush with the vertical side wall of the pole 32 thereby insuring that it is at the proper angle for illumination.

The universal mount luminaire 10 of the present invention thus has a support arm 20 which is mountable on two different axis, a vertical axis and a horizontal axis wherein a lighting pole extends upwardly along the vertical axis and wherein a davit arm may extend horizontally along a second axis. Adaptation for mounting on the two different axis or planes does not require utilization of exterior adaptation brackets or other hardware and is constructed integrally with the design of the support arm 20 or of the luminaire housing alternatively. A vertical mount position is provided by having a circular mount plate 29 which may have a curved face for flush mating with a circular light pole. A horizontal mount position may be provided for by inserting a davit arm into the interior of the support arm and held therein by a clamping bracket 25. Thus the universal mount luminaire of the present invention provides a means for horizontal mounting and a means for vertical mounting of the luminaire onto a lighting pole which has a vertical axis or a horizontal axis.

The foregoing detailed description is primarily given for clearness of understanding for the universal mount luminaire of the present invention and no unnecessary limitations are to be understood therefrom or from the particular examples or embodiments and functions given herein. Modifications and other variations may be available to those skilled in the art upon reading of the disclosure contained herein including the figures and submitted claims without parting from the spirit of the invention or the scope of the appended claims.

I claim:

1. A universal mount luminaire, comprising:
a housing, said housing having an illumination source located therein;
a support arm affixed to said housing, said support arm having a mounting plate and an integral davit arm aperture.

2. The universal mount luminaire of claim 1 wherein said support arm further has a clamp bracket for securely affixing said support arm to a light pole inserted through said davit arm aperture.

3. The universal mount luminaire of claim 2 further comprising a leveling bracket extending along an upper surface of said support arm and opposing said clamp bracket.

4. The universal mount luminaire of claim 3 wherein said leveling bracket further comprises a leveling bolt extending through said leveling bracket and threadably received into said support arm.

5. The universal mount luminaire of claim 1 wherein said mounting plate is located on a distal end of said support arm opposite said housing.

6. The universal mount luminaire of claim 5 wherein said mounting plate has a curved surface and at least one bolt aperture extending therethrough, said at least one bolt aperture receiving a mounting bolt therethrough.

7. The universal mount luminaire of claim 1 wherein said support arm further has a removeably attached cover plate.

8. The universal mount luminaire of claim 1 wherein said support arm has in the interior thereof a curvilinear clamp bracket, and further wherein said support arm has at least one clamp bolt extending through said clamp bracket for securely affixing said clamp bracket to said support arm, further said support arm having a leveling bracket extending longitudinally therethrough, said leveling bracket further having a leveling bolt extending through said leveling bracket.

9. The universal mount luminaire of claim 1 further comprising a leveling mechanism within said support arm.

10. A wide area illumination lighting fixture, comprising:
a light fixture housing and a support arm, said support arm having a vertical mounting plate, said support arm further having a clamp bracket, said clamp bracket affixed to said support arm.

11. The wide area illumination lighting fixture of claim 10 wherein said support arm further has a davit arm aperture formed in said vertical mounting plate.

12. The wide area illumination lighting fixture of claim 10 wherein said support arm has a leveling bracket extending longitudinally therethrough.

13. The wide area illumination lighting fixture of claim 12 wherein said leveling bracket receives a leveling bolt, said leveling bolt threadably received into said support arm.

14. The wide area illumination lighting fixture of claim 10 wherein said vertical mounting plate is formed at a distal end of said support arm opposite said light fixture housing, said vertical mounting plate having at least one bolt receiving aperture extending therethrough and having an outward curved face.

15. The wide area illumination lighting fixture of claim 10 further comprising a leveling mechanism in said support arm, said leveling mechanism designed to compress against a davit arm extending longitudinally into said support arm.

16. The wide area illumination lighting fixture of claim 10 wherein said vertical mounting plate has an outwardly facing curvilinear mounting face.

17. A universal mount luminaire, comprising:
a fixture housing, a lamp within said fixture housing, and a lens affixed to said housing;
means for mounting said luminaire to a pole extending on a vertical axis;
means for mounting said luminaire to a pole extending along a horizontal axis;
a leveling mechanism within said luminaire.

18. A universal mount luminaire, comprising:
a luminaire housing, a lamp within said luminaire housing;
a support mount adapted to receive and securely affix a davit arm therein;
a support plate mountable on a vertical lighting support pole.

19. The universal mount luminaire of claim 18 wherein said support mount further has a clamp bracket affixed to said support mount and a leveling mechanism.

20. The universal mount luminaire of claim 19 wherein said leveling mechanism is a leveling bracket extending along a portion of the interior of said support mount and is adjustable therein.

21. The universal mount luminaire of claim 20 wherein said leveling bracket is securely affixed at a first end to said support mount and is movably adjustable at a second opposite distal end.

22. The universal mount luminaire of claim 21 wherein said leveling bracket has an aperture at said second end which receives a leveling bolt, said leveling bolt threadably received within said support mount.

23. The universal mount luminaire of claim 18 wherein said support plate is curved.
